(19) United States
(12) Patent Application Publication
(10) Pub. No.: US 2003/0058861 A1
(43) Pub. Date: Mar. 27, 2003

(54) Subscriber interfacing apparatus of an ATM switching system

(75) Inventor: Ki Taek Kim, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/207,090

(22) Filed: Jul. 30, 2002

(30) Foreign Application Priority Data
Sep. 24, 2001 (KR) 58942/2001

(51) Int. Cl. H04L 12/66

(52) U.S. Cl. 370/392; 370/411; 370/395.1

(57) ABSTRACT

A subscriber interfacing apparatus included, for example, in an ATM switching system operates as an interface between an internal switching apparatus and an external transmission line having a relatively high speed compared with the processing speed of the internal switching apparatus. The subscriber interfacing apparatus includes a high speed cell interfacing unit which performs a multiplexing/de-multiplexing function in association with a number of FIFOs to transmit data cells from a high-speed external transmission line to an internal interfacing apparatus which operates at a lower speed. In performing this function, the transmission order of cell data for each connection to the switching system is guaranteed by distinguishing the transmission route of each of the data cells to be transmitted to respective connections in the switching apparatus. Furthermore, the cell multiplexing/de-multiplexing function may be performed in real-time in order to minimize transmission delay time, and various cell conversions may be performed through the application of Content Addressable Memory (CAM) units.

### BACKGROUND OF THE INVENTION

1. Field of the Invention

The present invention relates to Asynchronous Transfer Mode (ATM) switching systems, and more particularly to an apparatus and method for interfacing the communication of information between an ATM switching system and an external transmission device.

2. Background of the Related Art

A subscriber interfacing apparatus used for an ATM switching system transmits data between an external data transmission apparatus and a switching apparatus, the latter of which sets up data routes within the system. In order to perform this function, the subscriber interface apparatus accommodates a variety of physical-layer communication methods (for example, E1, T1, E3, T3, STM-1, STM-4, STM-4C, etc.), converts ATM cell forms between a 64 byte internal cell of the ATM switching system and a 53 octet (53 byte) standard ATM cell, and performs Virtual Path Connection (VPC)/Virtual Channel Connection (VCC) registration/release functions, Operation Administration and Maintenance (OAM) functions, and traffic management functions.

A 53-byte ATM cell is often used to achieve consistency in data transmissions to the ATM switching system. Cells used within the ATM switching system are often of an extended form of the 53-byte ATM cell. Because no rule exists which requires these cells to have a specific form, different forms or formats of cells are currently used for different ATM switching systems.

Another feature of interest in these systems relates to transmission speed. The transmission speed of a single line in the internal switching apparatus of the ATM switching system must be higher than or as high as the transmission speed of a transmission line connected to the external data transmission apparatus. If the transmission speed of the external line is higher than the transmission speed of the internal line, it is necessary to bind several transmission lines of the internal switching apparatus in order to implement a transmission speed that is at least the same as the transmission speed of the external line. In this case, it is desirable to maintain the order of data transmitted through respective transmission lines of the internal switching apparatus. If the order of transmission data at the internal switching apparatus is not maintained, the transmission speed of the external transmission line may not be higher than the transmission speed of the internal transmission line.

FIG. 1 shows a subscriber interfacing apparatus in an ATM switching system according to a related art. This apparatus comprises a physical layer processor 11, an OAM processor 12, a traffic management unit 13, an internal switching apparatus interface unit 14, and a control management unit 15.

The physical layer processor 11, which is connected to the external transmission line, converts physical layer data, such as E3, STM-1, etc., into ATM cell data which is then transmitted to the OAM processor 12.

The OAM processor 12 receives the ATM cells and transmits them to the traffic management unit 13, thereby performing an OAM function for the specific connection or link, which is set up by the control management unit 15.

The traffic management unit 13 receives the ATM cells for which the OAM function was performed from the OAM processor 12 and transmits them to the internal switching apparatus interface unit 14, performing a Usage Parameter Control (UPC) for each connection and scheduling for each class, etc.

The internal switching apparatus interface unit 14 synchronizes with the internal switching apparatus in order to transmit and receive ATM cell data to and from the internal switching apparatus, and transmits cells to the internal switching apparatus after converting the form of the cells when it is necessary.

The control management unit 15 controls and manages all composition blocks in the subscriber interfacing apparatus and thus enables the relevant subscriber data interfacing function to be performed.

The foregoing explanation of each composition part of the subscriber interfacing apparatus is provided with respect to a case where data are transmitted from the external transmission line to the internal part of the ATM switching system. In a case where data are transmitted from the internal switching apparatus of the ATM switching system to the external transmission line, data are processed and transmitted in the reverse order of the foregoing explanation.

In the ATM switching system of the related art described above, if the transmission speed of the external transmission line is lower than the transmission speed of the transmission line at the internal switching apparatus, the physical layer processor 11 of the subscriber interfacing apparatus binds several external transmission lines together for data to be transmitted to the internal part of the switching system, and then transmits the data to the internal switching apparatus. For data to be transmitted to the external part of the ATM switching system, the physical layer processor 11 confirms the destination of each data, selects the appropriate external transmission line, and then transmits the data.

In the subscriber interfacing apparatus, to be able to use the external transmission line whose transmission speed is higher than the transmission speed of the internal switching apparatus, data which are transmitted through several transmission lines of the internal switching apparatus should be guaranteed to be in order, but the subscriber interfacing apparatus of the ATM switching system of the related art cannot guarantee the order of data transmitted through the transmission lines of the internal switching apparatus. Consequently, an external transmission line which has a higher transmission speed than an internal transmission line of the switching apparatus may not be interfaced in the conventional subscriber interfacing apparatus.

### SUMMARY OF THE INVENTION

One object of the present invention is to provide a method and apparatus which overcomes the drawbacks of the related art discussed above.

Another object of the present invention is to achieve the aforementioned object by providing a subscriber interfacing method and apparatus which guarantees an order of data transmitted through the transmission lines of an internal switching apparatus, such as, for example, an ATM switching apparatus. Such an apparatus and method is advantageous because it makes it possible to accommodate an external transmission line which has a higher speed than a processing speed of an internal interfacing apparatus. In accordance with one aspect of the invention, this is achieved by interfacing cell data for each connection through a high-speed cell interfacing unit, which includes a cell multiplexing/de-multiplexing unit, to a number of First-in First-out (FIFO) units in a subscriber interfacing apparatus of a switching system.

Another object of the present invention to guarantee the transmission order of cell data by differentiating data transmission routes of the internal part of the switching system for each connection, to remove additional transmission delay time by performing the real time cell multiplexing/de-multiplexing functions, and to make it possible to convert cells of ingress and egress parts of the interface in various manners by utilizing a Content Addressable Memory (CAM).

These and other objects and advantages of the present invention are achieved by providing a subscriber interfacing apparatus of switching system (e.g., an ATM system) comprising: a high speed cell interfacing unit which distinguishes high speed cells inputted from an external transmission line for each of a plurality of connections to the switching system, converts the cells into a cell format of the switching system, and then transmits the converted cells to the switching system through respective connection lines. The cell interfacing unit also converts cells from the internal switching apparatus into cells of the external transmission line through a single combined interfacing apparatus line.

In accordance with one aspect of the present invention, the high speed cell interfacing unit comprises: a FIFO memory unit which includes a number of ingress FIFOs and egress FIFOs which temporarily store cell data for each connection line, a cell multiplexing unit which stores high speed cell data transmitted from the external transmission line into the ingress FIFOs, and a cell de-multiplexing unit which receives cell data from the switching apparatus and transmits that data to the external transmission line. The data cells transmitted by the cell de-multiplexing unit and a cell format conversion unit are first converted from the cell format used in the switching system into the cell format of the switching apparatus.

The FIFO memory unit uses synchronous FIFO for partitioning the high speed cell data transmitted from the external transmission line and for then transmitting them to the internal switching apparatus.

The cell multiplexing unit comprises: an ingress cell multiplexing unit which distinguishes the high speed cell data transmitted from the external transmission line through the traffic management unit for each connection and stores them in the ingress FIFO for each connection of the FIFO memory unit. The cell de-multiplexing unit includes an egress cell de-multiplexing unit which receives cell data stored in the egress FIFO for each connection of the FIFO memory unit and transmits them to the traffic management unit in a single combined transmission line. A control interface unit undertakes an interface to the control management unit, reports cell synchronizing conditions and FIFO conditions to the control management unit, controls the ingress cell multiplexing unit and egress cell de-multiplexing unit according to requests of the control management unit, thereby performing the loop-back function for the transmission line test.

The ingress cell multiplexing unit recognizes the start of the high speed cell data transmitted from the traffic management unit with the ingress start signal of the cell, and stores the high speed cell data in the ingress FIFO for each connection of the FIFO memory unit by checking the number of the link to which the cell data will be transmitted according to the link field value of the cell header, after distinguishing the high speed cell data for each connection.

The ingress cell multiplexing unit also discards relevant cell data if it is confirmed from the link field value of the cell header that the relevant cell is an idle cell.

The egress cell de-multiplexing unit checks whether cell data exist in the egress FIFO for each connection in the round robin method in order to transmit the cell data stored in the egress FIFO for each connection of the FIFO memory unit to the traffic management unit in one combined transmission line. The egress cell de-multiplexing unit also transmits the relevant cell data to traffic management unit if the cell data exist in the egress FIFO, or generates and transmits an idle cell if the cell data do not exist in the egress FIFO.

The ingress cell multiplexing unit and the egress cell de-multiplexing unit may synchronize the high speed cell data by using one counter which comprises a number of 1 bit shift registers connected with a chain. Furthermore, if a loop-back field value of the relevant cell is a predetermined value, the cell is transmitted to the egress cell de-multiplexing unit through the loop-back signal line, and then to the traffic management unit.

The cell format conversion unit comprises: an ingress cell format conversion unit which converts the cell data stored in the ingress FIFO for each connection of the FIFO memory unit into the cell format used in the internal switching apparatus; an egress cell format conversion unit which converts data of the cell format used in the internal switching apparatus into the cell format used in the subscriber interfacing apparatus and then stores the data in the egress FIFO for each connection of FIFO memory unit; and a cell format conversion control unit which undertakes the interface with the control management unit, monitors cell synchronizing conditions and the Header Error Check (HEC), and performs the loop-back function for the transmission line test by controlling the ingress cell format conversion unit and the egress cell format conversion unit according to requests of the control management unit.

Furthermore, the cell format conversion unit further comprises a bus size conversion unit which converts cell data of byte unit, which have been converted into the cell format used in the internal switching apparatus by the ingress cell format conversion unit, into the cell data of nibble unit and then transmits the cell data to the internal switching apparatus, converts the cell data of nibble unit transmitted from the internal switching apparatus into the cell data of byte unit, and then transmits the cell data to the egress cell format conversion unit. The bus size conversion unit performs the loop-back of the cell data transmitted from the traffic management unit to the side of the egress, if a loop-back signal for the test is generated from the cell format conversion control unit.

The ingress cell format conversion unit checks whether the cell data exist in the ingress FIFO for each connection using a round-robin method in order to convert the cell data stored in the ingress FIFO for each connection of the FIFO memory unit into the cell format used in the internal switching apparatus.

The ingress cell format conversion unit also examines whether the relevant cell data is a user cell or an Inter Processor Communication (IPC) cell and reports the result of the examination to the cell format conversion control unit, if cell data exist in the ingress FIFO. If cell data do not exist in the ingress FIFO, the ingress cell format conversion unit generates and transmits an idle cell to the internal switching apparatus through the bus size conversion unit.

The ingress cell format conversion unit extracts cell format conversion information requested by the internal switching apparatus from a Content Addressable Memory (CAM) by using the Virtual Path Identifier (VPI)/Virtual Channel Identifier (VCI) value of the cell data stored in the ingress FIFO for each connection of the FIFO memory unit and converts it into the cell format used in the internal switching apparatus.

The egress cell format conversion unit receives independent cell synchronous signal and the cell data for each port connected to the internal switching apparatus interface unit, checks whether the cell is an idle cell or a useful cell, performs the cell format conversion and HEC for the useful cell, and stores it in the egress FIFO for each connection. Additionally, the egress cell format conversion unit extracts the connection tag value requested by the traffic management unit from the CAM by using the VPI/VCI value of the cell data used in the internal switching apparatus, which is transmitted from the bus size conversion unit and converts it into the cell format used in the traffic management unit of the subscriber interfacing apparatus.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements, wherein:

FIG. 1 is a block diagram of a subscriber interfacing apparatus of an ATM switching system according to a related art.

FIG. 2 is a block diagram of a subscriber interfacing apparatus for interfacing the high speed cell data in an ATM switching system according to a preferred embodiment of the present invention.

FIG. 3 is a detailed block diagram of the high speed cell interfacing unit illustrated in FIG. 2.

### DETAILED DESCRIPTION OF PREFERRED EMBODIMENTS

The present invention is a subscriber interfacing apparatus and method used, for example, for an ATM switching system which provides a high-speed cell data interfacing function which can guarantee a transmission order of data. In accordance with one embodiment, the present invention performs this function in the case where the transmission speed of an external line connected to the subscriber interfacing apparatus is higher than a transmission speed of a line of within the internal switching apparatus.

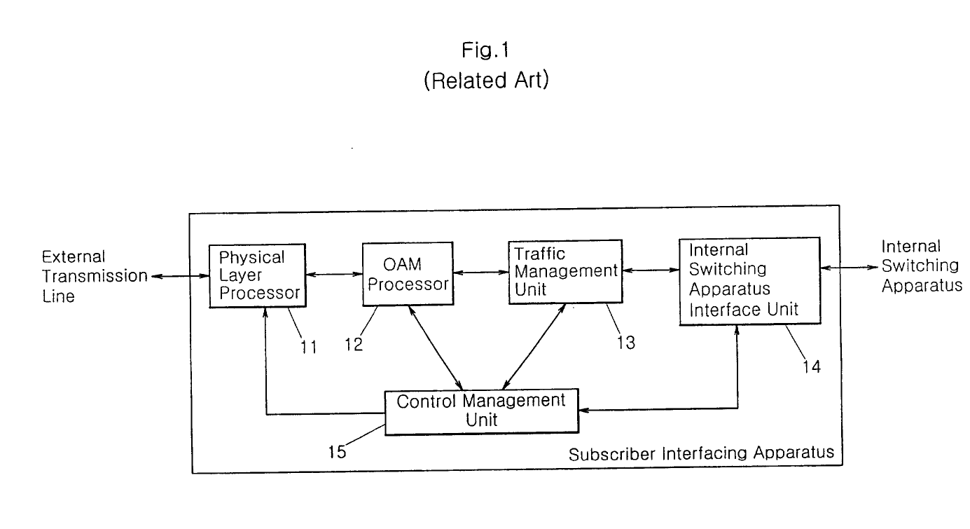

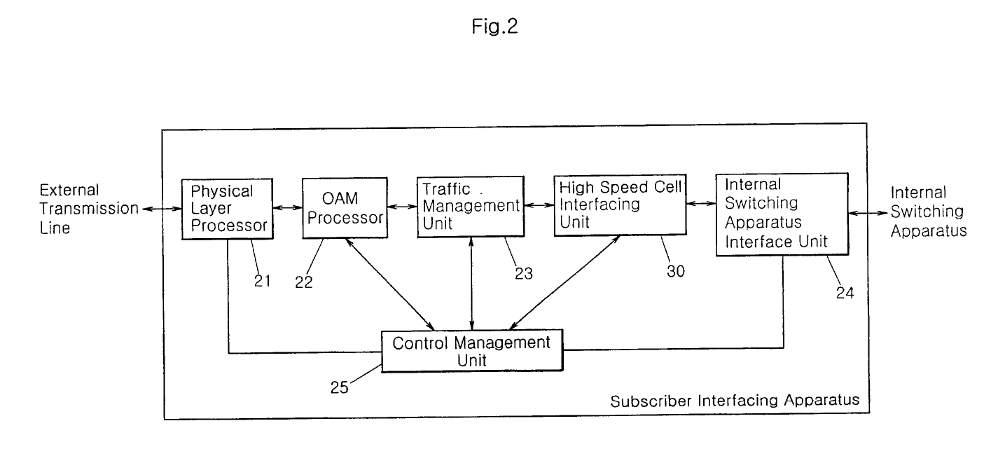

Referring to FIG. 2, an embodiment of the subscriber interfacing apparatus of the present invention includes a physical layer processor 21, an OAM processor 22, a traffic management unit 23, a high-speed cell interfacing unit 30, an internal switching apparatus interface unit 24, and a control management unit 25. Functions of the physical layer processor 21, the OAM processor 22, the traffic management unit 23, the internal switching apparatus interface unit 24, and the control management unit 25 maybe the same as those of the related art described with respect to FIG. 1. Further explanations of these features are therefore omitted.

The subscriber interfacing apparatus of the present invention differs from the related art, in at least one respect, by using the high-speed cell interfacing unit 30 between the traffic management unit 23 and the internal switching apparatus interface unit 24. The high-speed cell interfacing unit guarantees an order of data transmissions for each connection when data is transmitted between a high-speed external transmission line and a comparatively low-speed internal switching apparatus, and performs interfacing between them. To perform this function, the high speed cell interfacing unit 30 distinguishes cells (e.g., cells used in the subscriber interfacing apparatus) input from an external transmission line for the respective connection, converts the cells into an internal cell format (e.g., 64 bytes) of the ATM switching apparatus, and transmits the converted cells to the internal switching apparatus through each input line. On the other hand, the high speed cell interfacing unit 30 converts data in the internal cell format of the ATM switching apparatus into cells of the external transmission format, and then transmits these converted cells to the external transmission line through one single combined interfacing apparatus line.

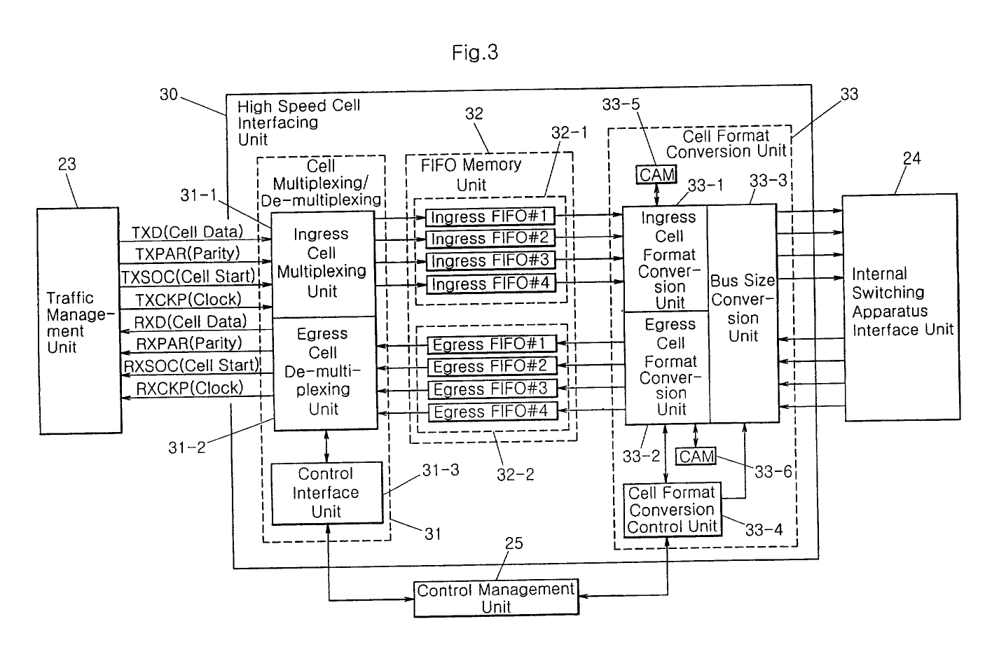

The high speed cell interfacing unit 30 is maybe described in greater detail with reference to FIG. 3. As shown, the high-speed cell interfacing unit 30 includes a cell multiplexing/de-multiplexing unit 31 which, after checking the link number for each connection, stores high speed cell data transmitted from the traffic management unit 23 in a FIFO memory unit 32. The high-speed cell interfacing unit also integrates into one transmission line the cell data stored in the FIFO memory unit 32 which have been transmitted from the internal switching apparatus. The FIFO memory unit 32, is equipped with a number of ingress FIFO 32-1 and egress FIFO 32-2, and temporarily stores cell data for each connection through the cell multiplexing/de-multiplexing unit 31. The high-speed cell interfacing unit also includes a cell format conversion unit 33 which converts a cell format from the cell format used in the subscriber interfacing apparatus, which is temporarily stored in the FIFO memory unit 32, to the cell format (e.g., 64 bytes) used in the internal switching apparatus, and vice versa.

A number of ingress FIFOs 32-1 and egress FIFOs 32-2 included in the FIFO memory unit 32 use synchronous FIFO for the division of the high speed of the external transmission (i.e., the transmission speed of the traffic management unit 23) within the subscriber interfacing apparatus and for the transmission to the internal switching apparatus. For example, in a case where the traffic management unit 23 transmits cell data at the speed of ‘8 bits×100 MHz’ and four FIFOs are used, respectively, for ingress and egress of the data, the cell data should be transmitted at the speed of ‘8 bits×4 FIFO×23.47471678 MHz’ for interfacing with the internal switching apparatus. At this time, the transmission order, the data order in other words, may be guaranteed because the cell data are stored in the designated FIFO for each connection.

The operation of the above-described high speed cell interfacing unit 30 will now be described relative to the composition of the cell multiplexing/de-multiplexing unit 31, the FIFO memory unit 32 and the cell format conversion unit 33.

The cell multiplexing/de-multiplexing unit 31, which is connected by one transmission line to the traffic management unit 23 of the subscriber interfacing apparatus for interfacing with a high-speed external transmission line, includes an ingress cell multiplexing unit 31-1 an egress cell de-multiplexing unit 31-2, and a control interface unit 31-3.

The transmission of cell data from the subscriber interfacing apparatus to the internal switching apparatus via unit 31 is conducted as follows. The ingress cell multiplexing unit 31-1 distinguishes the high-speed cell data transmitted from the traffic management unit 23 for each connection, checks the link number through which the cell data will be transmitted according to the relevant link field value of the cell header, and then stores the cell data in an ingress FIFO 32-1 corresponding to each connection of the FIFO memory unit 32. In this manner, the cell data transmission order may be guaranteed for each connection.

The ingress cell multiplexing unit 31-1 recognizes the start of high speed cell data transmitted from the traffic management unit 23 through the ingress start signal of the cell (TXSOC) and confirms the link field value of the cell header. If the link field value of the cell header indicates that the cell is an idle cell, the ingress cell multiplexing unit 31-1 discards the relevant cell data.

If the link field value of the header indicates the cell is a signal cell, the loop-back field value of the cell header is set with ‘1’, and the cell which has ‘1’ as its loop-back field value is transmitted to the egress cell de-multiplexing unit 31-2 through the loop-back signal line and then transmitted again to the traffic management unit 23.

The cell data stored in the ingress FIFO 32-1 for each connection of the FIFO memory unit 32 are converted into a cell format used in the internal switching apparatus by an ingress cell format conversion unit 33-1. The converted cell data are then transmitted to the internal switching apparatus interface unit 24. To perform this conversion function, the ingress cell format conversion unit 33-1 checks whether cell data exists in the ingress FIFO 32-1 for each connection in the FIFO memory unit 32. If cell data exists in the ingress FIFO 32-1, the ingress cell format conversion unit 33-1 checks whether the relevant cell is a user cell or an Inter Processor Communication (IPC) cell and reports the result of the check to a cell format conversion control unit 33-4.

Preferably, at the same time, the ingress cell format conversion unit 33-1 receives the cell data stored in the ingress FIFO 32-1, converts the cell data to a cell format used in the internal switching apparatus, and then transmits the cell data to the internal switching apparatus through a bus-size conversion unit 33-3. If no cell data exists in the ingress FIFO 32-1, the ingress cell format conversion unit 33-1 generates an idle cell and transmits the idle cell to the internal switching apparatus through the bus-size conversion unit 33-3.

For the conversion into the cell format used in the internal switching apparatus, the ingress cell format conversion unit 33-1 obtains from a CAM 33-5 cell format conversion information requested by the internal switching apparatus by using values of Virtual Path Identifier (VPI)/Virtual Channel Identifier (VCI).

The bus-size conversion unit 33-3 converts the cell data in a unit (e.g., a byte or octet) transmitted to the internal switching apparatus, after being converted into the cell format used in the internal switching apparatus by the ingress cell format conversion unit 33-1, into the cell data of a unit (e.g., a nibble) which is suitable for input into the internal switching apparatus interface unit 24 (e.g., from cell data of 8 bits to cell data of 4 bits) and transmits such data. If a loop-back signal is generated from the cell format conversion control unit 33-4 for test purposes, cell data transmitted from the traffic management unit 23 is loop-backed in the direction of egress.

Because the internal switching apparatus interface unit 24 requires input of exactly synchronized cell data through four ports of, for example, 155 Mbps, the ingress cell format conversion unit 33-1 receives cells from the ingress FIFO 32-1 at the same cell timing. If the ingress cell format conversion unit 33-1 is implemented with a number of devices, a synchronization input signal line and a synchronization output signal line may be used for cell synchronization between each device. Here, the device whose master signal line is ‘full-up’ conducts functions as the master.

The transmission of cell data from the internal switching apparatus to the subscriber interfacing apparatus may be conducted as follows. First, as shown in FIG. 3, the bus-size conversion unit 33-3 is connected through a number of transmission lines (transmission ports) to the internal switching apparatus, which has a low speed compared with the external transmission line. The bus-size conversion unit converts cell data in a unit (e.g., a nibble) transmitted from the internal switching apparatus interface unit 24 into cell data of another unit (e.g., the byte unit) and transmits the cell data to the egress cell format conversion unit 33-2.

The egress cell format conversion unit 33-2 converts the data of the cell format used in the internal switching apparatus, which are transmitted from the bus size conversion unit 33-3, into the cell format used in the subscriber interfacing apparatus and stores them in the egress FIFOs 33-2 corresponding to each connection of the FIFO memory unit 32. At this time, the egress cell format conversion unit 33-2 receives an independent cell synchronization signal and cell data for each port connected to the internal switching apparatus interface unit 24, and then checks whether the relevant cell is an idle cell or a useful cell. If it is determined to be a useful cell, it is stored in the egress FIFO 32-2 for each connection after the cell format conversion and the Header Error Check (HEC).

To perform the conversion into the cell format used in the subscriber interfacing apparatus (namely, the traffic management unit 23), the egress cell format conversion unit 33-2 extracts the cell format conversion information, such as the connection tag value, which is requested by the traffic management unit 23, from a CAM 33-6 by using the VPI/VCI value.

The cell format conversion unit 33 further includes the cell format conversion control unit 33-4, in addition to the ingress cell format conversion unit 33-1, the egress cell format conversion unit 33-2, and the bus size conversion unit 33-3. The cell format conversion control unit 33-4undertakes interfacing with the control management unit 25, monitors the cell synchronizing status or the existence of any error from the HEC, and controls the ingress cell format conversion unit 33-1 and the egress cell format conversion unit 33-2 according to a request of the control management unit 25, thereby performing the loop-back function for the transmission line test.

The cell data stored in the egress FIFO 32-2 for each connection of the FIFO memory unit 32 by the egress cell format conversion unit 33-2 are transmitted to the traffic management unit 23 through a single combined transmission line by the egress cell de-multiplexing unit 31-2. At this time, the egress cell de-multiplexing unit 31-2 checks, for example, by a round robin method, whether cell data exists in the egress FIFO 32-2 for the respective connection. If cell data exist in the egress FIFO 32-2, the relevant cell data are transmitted in one single transmission line which is connected to the traffic management unit 23. If cell data does not exist in the egress FIFO 32-2, an idle cell is generated and transmitted to the traffic management unit 23.

The cell multiplexing/de-multiplexing unit 31 further includes a control interface unit 31-3 in addition to the ingress cell multiplexing unit 31-1 and the egress cell de-multiplexing unit 31-2. The control interface unit 31-3 undertakes interfacing with the control management unit 25, reports the cell synchronizing status and the FIFO status to the control management unit 25, and controls the ingress cell multiplexing unit 31-1 and the egress cell de-multiplexing unit 31-2 according to a request of the control management unit 25, thereby performing the loop-back function for the transmission line test, etc.

The ingress cell multiplexing unit 31-1 and the egress cell de-multiplexing unit 31-2 of the cell multiplexing/de-multiplexing unit 31 preferably uses one counter (not illustrated in drawings), which includes a number of 1-bit shift registers connected in a chain, for the high-speed cell data synchronization. Those skilled in the art can appreciate, however, that other circuit arrangements may be used to perform this synchronization functions.

Thus, the present invention is a method and apparatus which interfaces cell data for each relevant connection by implementing the high speed cell interfacing unit using the multiplexing/de-multiplexing function and a number of FIFO at the subscriber interfacing unit of an ATM switching system which is connected to a high speed of external transmission line, it is possible to accommodate an external transmission line of a higher speed than the processing speed of the internal interfacing apparatus.

Also, the present invention guarantees the transmission order of cell data for each connection because the present invention distinguishes the data transmission route for each connection in the switching apparatus. Furthermore, because the cell multiplexing/de-multiplexing function of the present invention may be performed in real time, there is almost no additional transmission delay time and various cell conversions are made possible through the application of the CAM at the ingress and the egress.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to of those skilled in the art. In the claims, means-plus-function clauses are intended to cover the structures described herein as performing the recited function and not only structural equivalents but also equivalent structures

What is claimed is:

1. An interface for communicating data between a switching system and an external device, comprising:
a first cell interfacing unit which distinguishes cells from an external transmission line, converts the cells into a format of the switching system, and transmits the converted cells to the switching system in a predetermined order.

2. The interface of claim 1, wherein the first cell interfacing unit distinguishes transmission routes for the cells received from the external transmission line, and transmits the converted cells in the predetermined order based the transmission routes.

3. The interface of claim 1, wherein the first cell interfacing unit comprises:
a number of ingress FIFOs which store the cells received from the external transmission line, wherein the number of ingress FIFOs correspond to a number of connection lines which input cell data into the switching system;
a cell multiplexing unit which routes the cells received from the external transmission line into respective ones of the ingress FIFOs; and
a cell format conversion unit which converts the cells stored in the ingress FIFOs into the format of the switching system.

4. The interface of claim 3, wherein the ingress FIFOs output the cells received from the external transmission line based on a synchronous FIFO scheme.

5. The interface of claim 3, further comprising:
a control interface unit which monitors cell synchronizing status and FIFO status information.

6. The interface of claim 3, further comprising:
a control interface unit which controls the cell multiplexing unit according to requests of a control management unit.

7. The interface of claim 3, wherein the control interface unit controls the cell multiplexing unit to perform a cell loop-back function during a transmission line test.

8. The interface of claim 3, wherein the cell multiplexing unit recognizes a start of cell data transmitted from the external transmission line based on a start signal transmitted from a traffic management unit.

9. The interface of claim 3, wherein the cell multiplexing unit routes each of the cells received from the external transmission line to a respective one of the ingress FIFOs by checking a number of a link to which the received cells are to be transmitted.

10. The interface of claim 9, wherein the cell multiplexing unit determines a number of a link for each of the cells based on header information in each of the cells.

11. The interface of claim 10, wherein said header information corresponds to a link field value.

12. The interface of claim 11, wherein the cell multiplexing unit discards a cell received from the external transmission line if a link field value in a header of the cell is an idle cell.

13. The interface of claim 3, further comprising:
a counter which includes a number of 1-bit shift registers connected in a chain,
wherein the cell multiplexing unit synchronizes routing of the cells received from the external transmission line based on a count in the counter.

14. The interface of claim 3, wherein the cell format conversion unit includes:
a cell format conversion control unit which monitors cell synchronizing conditions and a Header Error Check, and performs a loop-back function during a transmission line test.

15. The interface of claim 14, wherein the cell format conversion unit includes:
a bus-size conversion unit which converts bytes of the cells stored in the ingress FIFOs into nibbles.

16. The interface of claim 3, wherein the cell format conversion unit checks whether cells are stored in the ingress FIFOs using a round-robin method.

17. The interface of claim 16, wherein the cell format conversion unit determines whether the cells stored in the ingress FIFOs are user cells or IPC cells.

18. The interface of claim 16, wherein the cell format conversion unit transmits an idle cell to the switching system if a cell is not stored in one of the ingress FIFOs.

19. The interface of claim 3, wherein the cell format conversion unit acquires cell-format conversion information from a CAM using a VPI/VCI value, and then converts the cells stored in the ingress FIFOs into the format of the switching system based on the cell-format conversion information.

20. The interface of claim 1, further comprising:
a second cell interfacing unit which converts cells from the switching system into a format of the external transmission line, and transmits the converted cells to the external transmission line.

21. The interface of claim 20, further comprising:
an interface line connected between the external transmission line and the second cell interfacing unit, wherein the second cell interfacing unit transmits the converted cells to the external transmission line through the internal interface line.

22. The interface of claim 20, wherein the second cell interfacing unit comprises:
a cell format conversion unit which converts the cells from the switching system into the format of the external transmission line;
a number of egress FIFOs which temporarily store the converted cells received from the cell format conversion unit, wherein the number of egress FIFOs correspond to a number of connection lines which output cell data from the switching system; and
a cell demultiplexing unit which routes the converted cells stored in the egress FIFOs through a single internal interface line for output to the external transmission line.

23. The interface of claim 22, further comprising:
a control interface unit which monitors cell synchronizing status and FIFO status information.

24. The interface of claim 22, further comprising:
a control interface unit which controls the cell demultiplexing unit according to requests of a control management unit.

25. The interface of claim 22, wherein the cell demultiplexing unit routes the converted cells stored in the egress FIFOs using a round-robin method.

26. The interface of claim 22, wherein the cell demultiplexing unit checks whether converted cells are stored in the egress FIFOs, and if converted cells are stored in the egress FIFOs the cell demultiplexing unit transmits the converted cells to a traffic management unit, and for egress FIFOs which do not store converted cells the cell demultiplexing unit transmits a idle cell.

27. The interface of claim 22, further comprising:
a counter which includes a number of 1-bit shift registers connected in a chain,
wherein the cell demultiplexing unit synchronizes routing of the cells stored in the egress FIFOs based on a count of the counter.

28. The interface of claim 22, further comprising:
a cell multiplexing unit which routes the cells received from the external transmission line into respective ones of the ingress FIFOs, and wherein the cell demultiplexing unit transmits a cell output from the cell multiplexing unit based on a loop-back signal if a loop-back field value of the cell is a predetermined value.

29. The interface of claim 22, wherein the cell format conversion unit includes:
a bus-size conversion unit which converts nibbles of the cells received from the switching system into bytes.

30. The interface of claim 29, wherein the bus-size conversion unit perform a loop-back operation in which a cell received from the external transmission line and converted into a format of the switching system is routed back to the cell de-multiplexing unit.

31. The interface of claim 22, wherein the cell format conversion unit acquires a connection tag value from a CAM using a VPI/VCI value, and then converts the cells from the switching system into the format of the external transmission line based on the connection tag value.

32. The interface of claim 22, wherein the cell format conversion unit receives a cell synchronous signal through one of the connection lines output from the switching system, determines whether a cell from said one connection line is an idle cell or useful cell, converts the cell into the format of the external transmission line, and stores the converted cell in one of the egress FIFOs.

33. A method for communicating data between a switching system and an external device, comprising:
distinguishing transmission routes for cells received from an external transmission line;
storing the cells received the external transmission line in respective FIFOs;
converting the cells stored in the FIFOs into a format of the switching system; and
transmitting the converted cells to the switching system in a predetermined order based on the transmission routes distinguished in said distinguishing step.

34. The method of claim 33, wherein a synchronous FIFO scheme is used to distinguish the transmission routes for the cells received from the external transmission line.

35. The method of claim 33, further comprising:
routing each of the cells received from the external transmission line to a respective one of the FIFOs by checking a number of a link to which the received cells are to be transmitted.

36. The method of claim 35, further comprising:
determining a number of a link for each of the cells based on header information in each of the cells.

37. The method of claim 36, wherein said header information corresponds to a link field value.

38. The method of claim 37, further comprising:
discarding a cell received from the external transmission line if a link field value in a header of the cell is an idle cell.
